(19) United States
(12) Patent Application Publication
(10) Pub. No.: US 2025/0060707 A1
(43) Pub. Date: Feb. 20, 2025

(54) Growing panes

(71) Applicant: Caroline C. Solecki, Albuquerque, NM (US)

(72) Inventor: Caroline C. Solecki, Albuquerque, NM (US)

(21) Appl. No.: 18/766,476

(22) Filed: Jul. 8, 2024

Related U.S. Application Data
(60) Provisional application No. 63/533,164, filed on Aug. 17, 2023.

(51) Int. Cl. G04B 49/02

(52) U.S. Cl. CPC G04B 49/02

(57) ABSTRACT

A growing pane is made of a base, a plurality of triangular gnomons placed one section apart, and arranged at different positions which are suited for the stage it holds, a rod-like gnomon that provides support to the plurality of triangular gnomons for defining an intended use of telling time and the stainless glass creates a solid line of shadow that defines the colored reflection of the opaque design, wherein, the opaque design in the plurality of triangular gnomons projected to the surface when the sunlight falls over the clear pane of glass. The opaque design in the plurality of triangular gnomons changes the position on the surface when the position of the sun changes.

### TECHNICAL FIELD

The embodiments herein generally relate to growing panes and more particularly, relate to the growing panes that cast a singular shadow to tell the time and reflect colored light by creating an image of an object in motion over the course of the day.

### DESCRIPTION OF THE RELATED ART

The sundial is an observing instrument that measures the time using shadows created by the sun. Many sundials are installed permanently and may not be repositionable. Many sundials may display the wrong time of day and/or year when shifted due to their permanent installation. The gnomon is commonly fixed at the center of the surface of the revolution. On the frontal side of the sundial, where the young man's shadow was visible, a visual line was drawn. The moment was timed by measuring the angle at which the young man's shadow met the visual axis. Many compasses can be classified as one of four types, namely: fixed-dial, floating dial, cruiser, and orienteering. The sun throws a shadow from a style onto a clock face marked with lines representing the hours of the day in popular designs like the horizontal sundial. The sundial is made by placing a bar perpendicular to the ground and drawing a radial line that divides the circumference into 24 equal parts. There are 2 kinds of sundial gnomons a perfectly centered vertical rod, an angle based on the latitude of the intended use of the sundial, triangular plane that crosses the diameter of the circular base. Sundials are also divided into 12 sections to represent the 12 hours of sunlight that it catches.

There are two known types of stainless-glass patterns for the decoration of an eyeglass. However, because the patterns are not set back from but rather are set even with the surface of the eyeglass frame, the known patterns are too flat to evoke the picture of stainless glass installed in a building.

A need exists, therefore, for a device that casts a singular shadow to tell the time and reflects colored light that creates an image of an object in motion over the course of the day.

### SUMMARY OF THE INVENTION

In view of the foregoing, an embodiment herein provides a growing pane. A growing pane, wherein the growing pane is made of a base; and a plurality of triangular gnomons, wherein each of the plurality of triangular gnomons is comprised of a transparent pane, wherein at least one of the transparent panes includes an opaque design, the plurality of triangular gnomons being positioned around a vertical support structure connected to the base. wherein, the stainless glass image in the plurality of triangular gnomons projected to a surface when sunlight falls over a clear pane of glass, wherein the opaque design in the plurality of triangular gnomons is projected onto a surface and the position of the projected design on the surface changes when the position of a sun changes.

In one exemplary embodiment, the growing pane is made of a base, a plurality of triangular gnomons, and a rod-like gnomon. The rod-like gnomon provides support to the plurality of triangular gnomons for defining an intended use of telling time, and a stainless glass creates a solid line of shadow that defines a colored reflection of a stainless-glass image. The stainless glass image in the plurality of triangular gnomons projected to a surface when sunlight falls over a clear pane of glass. The stainless-glass image in the plurality of triangular gnomons changes the position on the surface when the position of a sun changes. In some embodiments. wherein the clear pane of glass includes a stainless-glass image, wherein the stainless-glass creates a solid line of shadow that defines the colored reflection of the stainless-glass image.

Another inventive aspect of the subject matter includes a method to project a decorative image onto a surface. This method includes the steps of positioning a growing pane, wherein the growing pane is made of a base; and a plurality of triangular gnomons, wherein each of the plurality of triangular gnomons is comprised of a transparent pane, wherein at least one of the transparent panes includes an opaque design, the plurality of triangular gnomons being positioned around a vertical support structure connected to the base in sunlight, receiving sunlight on to one of the plurality of triangular gnomons, projecting the decorative image on to a surface at a first location; receiving sunlight on to another of the plurality of triangular gnomons; and projecting the decorative image onto a surface at a second location.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The embodiments herein will be better understood from the following detailed description with reference to the drawings, in which:

FIG. 1 illustrates a structural diagram of growing panes according to an embodiment herein;

FIG. 2 illustrates an exemplary view of the growing pane according to an embodiment herein; and

FIG. 3 illustrates a flow chart of the growing pane according to an embodiment herein.

### DETAILED DESCRIPTION OF PREFERRED EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

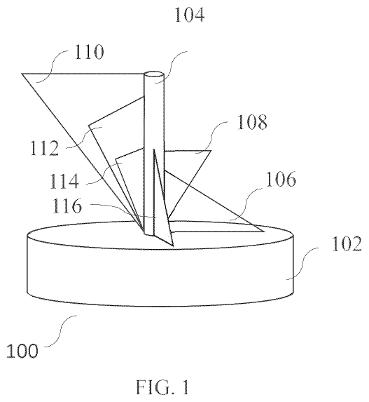

FIG. 1 illustrates a structural diagram of a growing pane 100 according to an embodiment herein. The growing pane 100 is made of a base 102, a plurality of triangular gnomon 106-116, and a vertical support structure 104. A gnomon is the section of a sundial that is configured to cast a shadow. The base 102 is stable and the rod-like gnomon 104 is connected to the base 102. The plurality of the triangular gnomon 106-116 are connected to the vertical support structure 104. The base 102 may be made of wood, metal, ceramic, plastic, stone, or glass. The vertical support structure 104 supports the plurality of triangular gnomon 106-116. In some embodiments, the vertical support structure 104 may be made of solid metal or wood. The plurality of gnomons 106-116 is arranged at different positions that are suited for the stage it holds. In some embodiments, the plurality of gnomons 106- 116 are six triangular gnomons that are different but proportional in size that incrementally get larger.

The growing pane 100 is made of a vertically placed support structure 104 over the base 102. The plurality of triangular gnomons 106-116 are connected to the vertical support structure 104. The plurality of triangular gnomon 106-116 are made of a first pane 106, second pane 108, third pane 110, fourth pane 112, fifth pane 114, and sixth pane 116. The second pane 108 and third pane 110 are placed farthest from the viewer. The first pane 106 and fourth pane 112 are placed midway to the viewer. The fifth pane 114 and sixth pane 116 are placed closest to the viewer. The first pane 106, second pane 108, third pane 110, fourth pane 112, fifth pane 114, and sixth pane 116 are made of a transparent rigid material. For example, the panes can be made of glass or plastic. Examples of plastic that can be used in lieu of glass: PET (polyethylene terephthalate), LOPE (Low-Density Polyethylene), PP (polypropylene), polycarbonate and acrylic. In one embodiment, the first pane 106, second pane 108, third pane 110, fourth pane 112, fifth pane 114, and sixth pane 116 are made of a plurality of images in the stainless glass panels.

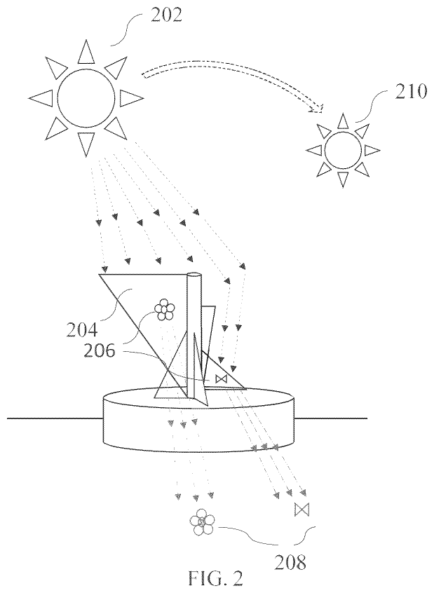

FIG. 2 illustrates an exemplary view of the growing pane 100 according to an embodiment herein. The exemplary view includes sun 202, a clear pane of glass 204, an image projected onto the ground 208, and the position of the sun after changing 210. When the sunlight from sun 202 falls on the clear pane of glass 204, an opaque design 206 in the plurality of triangular gnomons 106-116 is projected on the ground 208. The clear pane of glass 204 includes an opaque design 206. In some embodiments, the opaque design 206 may be a flower, starting with the seed and ending with the flower wilting. In some embodiments, the opaque design 206 may be changed by a user based on their needs. The clear pane of glass 204 is made up of colored glass. The stainless glass creates a solid line of shadow that defines the colored reflection of the opaque design 206. In some embodiments, the glass panes 204 may be changed to depict different subjects in motion.

The opaque design 206 in the plurality of triangular gnomons 106-116 is projected to the surface when the sunlight falls over the clear pane of glass 204. The opaque design 206 in the plurality of triangular gnomons 106-116 changes position on the surface when the position of the sun 202 changes.

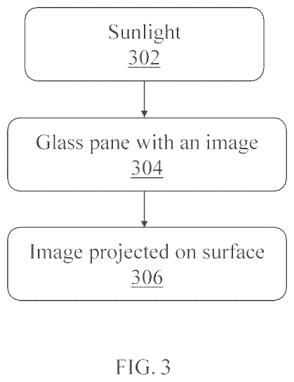

FIG. 3 illustrates a flow chart of the growing pane 100 according to an embodiment herein. The flow chart includes the process of at step 302, the sunlight from the sun 202; at step 304, the sunlight falls on the glass pane 204 with an image; at step 306, the opaque design 206 is reflected onto a surface creating the image 208 that changes as the sun changes its position 210.

In some embodiments, the growing pane 100 may be used as a decorative object in indoor or outdoor, art galleries, museums, and school parks. The growing pane 100 may be used for profit purposes and non-profit purposes. In some embodiments, glass pane 204 includes at least one glass, stainless glass, polyethylene, or polypropylene. The growing pane 100 may be scaled up or down, installed in larger or smaller sizes, or used as garden ornamental or sculptural pieces. In some embodiments, the growing pane 100 must be placed in direct contact with the sunlight for the whole day. The image cast by the growing pane 100 may change throughout the day, completely depending on the sun's location in the sky.

What is claimed is:

1. A growing pane, wherein the growing pane comprises:
a base; and
a plurality of triangular gnomons, wherein each of the plurality of triangular gnomons is comprised of a transparent pane, wherein at least one of the transparent panes includes an opaque design, the plurality of triangular gnomons being positioned around a vertical support structure connected to the base. wherein, the stainless glass image in the plurality of triangular gnomons projected to a surface when sunlight falls over a clear pane of glass, wherein the opaque design in the plurality of triangular gnomons is projected onto a surface and the position of the projected design on the surface changes when the position of a sun changes.

2. The growing pane as claimed in claim 1, wherein the plurality of triangular gnomons is comprised of: a first pane 106, a second pane 108, a third pane 110, a fourth pane 112, a fifth pane 114, and a sixth pane 116.

3. The growing pane as claimed in claim 1, wherein the plurality of triangular gnomons proportional are in size that incrementally increase in size.

4. A method to project a decorative image on to a surface comprising:
positioning a growing pane, wherein the growing pane comprises:
a base; and
a plurality of triangular gnomons, wherein each of the plurality of triangular gnomons is comprised of a transparent pane, wherein at least one of the transparent panes includes an opaque design, the plurality of triangular gnomons being positioned around a vertical support structure connected to the base in sunlight;
receiving sunlight on to one of the plurality of triangular gnomons,
projecting the decorative image on to a surface at a first location;
receiving sunlight on to another of the plurality of triangular gnomons; and
projecting the decorative image onto a surface at a second location.
